(19) United States
(12) Patent Application Publication
(10) Pub. No.: US 2006/0103737 A1
(43) Pub. Date: May 18, 2006

(54) Image capturing apparatus, electronic processing terminal and image processing system

(75) Inventors: Noriyuki Okisu, Osakasayama-shi (JP); Motohiro Nakanishi, Kobe-shi (JP); Jun Minakuti, Sakai-shi (JP); Tsutomu Honda, Sakai-shi (JP)

Correspondence Address: SIDLEY AUSTIN LLP, 717 NORTH HARWOOD, SUITE 3400, DALLAS, TX, 75201, US

(73) Assignee: KONICA MINOLTA PHOTO IMAGING, INC.

(21) Appl. No.: 11/075,566

(22) Filed: Mar. 9, 2005

(30) Foreign Application Priority Data
Nov. 18, 2004 (JP) JP2004-334464

(51) Int. Cl. H04N 5/228

(52) U.S. Cl. 348/222.1

(57) ABSTRACT

An image processing system capable of reducing processing time is provided. A digital camera and a PC are connected to each other with a cable for making communications under USB or the like. Image data of a RAW image and computing parameters are transmitted from the PC to the digital camera through the cable. The image data received by the digital camera is sequentially subjected to processing based on the computing parameters in a white balance controller, a pixel interpolator, a color space converter, a gamma converter, a YCrCb converter, an edge enhancer, an LPF part and an RGB converter. The image data having undergone the above processing is transmitted from the digital camera to the PC through the cable.

This application is based on application No. 2004-334464 filed in Japan, the contents of which are hereby incorporated by reference.

### BACKGROUND OF THE INVENTION

1. Field of the Invention

The present invention relates to processing on image data captured by a digital camera.

2. Description of the Background Art

As file formats for image data captured by digital cameras, JPEG format and TIFF format are known. However, file generation in the JPEG format or TIFF format causes a problem of deterioration in image data. Hereinbelow, a procedure for file generation and reasons for such deterioration will be discussed.

In digital cameras, image data captured by a CCD is converted into digital form in an AD converter. Then, shading correction, white balance control, pixel interpolation, color space conversion and gamma conversion are conducted as necessary, and thereafter, YCrCb conversion is performed to generate a luminance image and a color difference image. The luminance image is subjected to sharpness adjustment (edge enhancement), and the color difference image is subjected to smoothing.

In the JPEG format, the luminance image and color difference image are subjected to JPEG compression, and then generated into an image file (JPEG file). In the TIFF format, the luminance image and color difference image are subjected to RGB conversion, and then generated into an image file (TIFF file).

Data having undergone AD conversion generally has a bit length greater than 8 bit, however, the bit length gradually decreases in the above-described image processing. (For instance, data originally having a 12-bit length is brought into a 10-bit length after color space conversion, and an 8-bit length after gamma conversion.) Finally, image data has an 8-bit length in each of R (red), G (green) and B (blue) in the JPEG format or TIFF format.

The decrease in bit length and the occurrence of cancellation of significant digits means deterioration in data. Moreover, since JPEG compression is lossy compression, image deterioration is caused by compression.

RAW format is used as a file format for avoiding such image deterioration. In the RAW format, image data converted into digital form in the AD converter is subjected to shading correction only, and then generated into an image file (RAW file). Therefore, compression is not conducted, and cancellation of significant digits can be reduced to a minimum, allowing image deterioration to be reduced.

An image file generated in a digital camera is transmitted to an electronic processing terminal such as a PC (personal computer). In the JPEG or TIFF format, such image file can be viewed using an image processing application called a viewer, and image processing can further be performed. A RAW file can be viewed after conversion processing is performed thereon, and it is possible to perform image processing with high accuracy and high flexibility since various types of processing as described above are not performed previously on the RAW file.

As described, in the RAW format, image data having undergone AD conversion is subjected to shading correction only, and then generated into an image file. Therefore, in the case of performing conversion processing on the RAW file in the PC, image processing on the RAW file such as white balance control, pixel interpolation, color space conversion and gamma conversion needs to be performed in the PC. In this case, the RAW file has a great bit length and hence, a large volume of data, resulting in a problem of extended processing time.

### SUMMARY OF THE INVENTION

It is an object of the present invention to provide an image processing system capable of shortening processing time.

According to the present invention, an image processing system includes an image capturing apparatus and an electronic processing terminal connectable to the image capturing apparatus. The electronic processing terminal includes an instruction part for giving an instruction to perform predetermined processing on image data and an unprocessed data transmitter for transmitting the image data to be subjected to the predetermined processing to the image capturing apparatus. The image capturing apparatus includes a receiver for receiving the image data transmitted from the electronic processing terminal, a processor for performing the predetermined processing on the image data as received to obtain processed image data, the processor having a specific processor specifically designed to a certain image processing function including the predetermined processing, and a processed data transmitter for transmitting the processed image data to the electronic processing terminal.

The predetermined processing is performed in the specific processor included in the image capturing apparatus, not in the electronic processing terminal. Since this specific processor is specifically designed to a certain image processing function including the predetermined processing, it is possible to shorten processing time as compared to the case of using a general-purpose functional processor in the electronic processing terminal.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a configuration of an image processing system according to a first preferred embodiment of the present invention;

FIG. 2 is a rear view of a digital camera according to the first preferred embodiment;

FIG. 3 is a detailed block diagram of the digital camera according to the first preferred embodiment;

FIG. 4 shows a configuration of a CCD;

FIG. 5 is a detailed block diagram of a PC;

FIGS. 6A to 6C show a basic operation of the image processing system according to the first preferred embodiment;

FIG. 7 is a detailed flow chart of an operation of the image processing system according to the first preferred embodiment;

FIG. 8 is a flow chart of an operation of the PC shown in FIG. 5;

FIG. 9 is a flow chart of an operation of the digital camera according to the first preferred embodiment;

FIG. 10 is a flow chart of an operation of a digital camera according to a second preferred embodiment of the present invention;

FIG. 11 is a flow chart of an operation of the digital camera according to the second preferred embodiment;

FIG. 12 is a flow chart of an operation of a digital camera according to a third preferred embodiment of the present invention;

FIG. 13 is a flow chart of an operation of a PC according to a fourth preferred embodiment of the present invention;

FIG. 14 is a schematic view of RAW data format according to a fifth preferred embodiment of the present invention;

FIG. 15 is a flow chart of a digital camera according to a fifth preferred embodiment;

FIG. 16 is a flow chart of a digital camera according to a sixth preferred embodiment of the present invention; and

FIG. 17 is a flow chart of an operation of a PC according to a seventh preferred embodiment of the present invention.

### DESCRIPTION OF THE PREFERRED EMBODIMENTS

### First Preferred Embodiment

Configuration

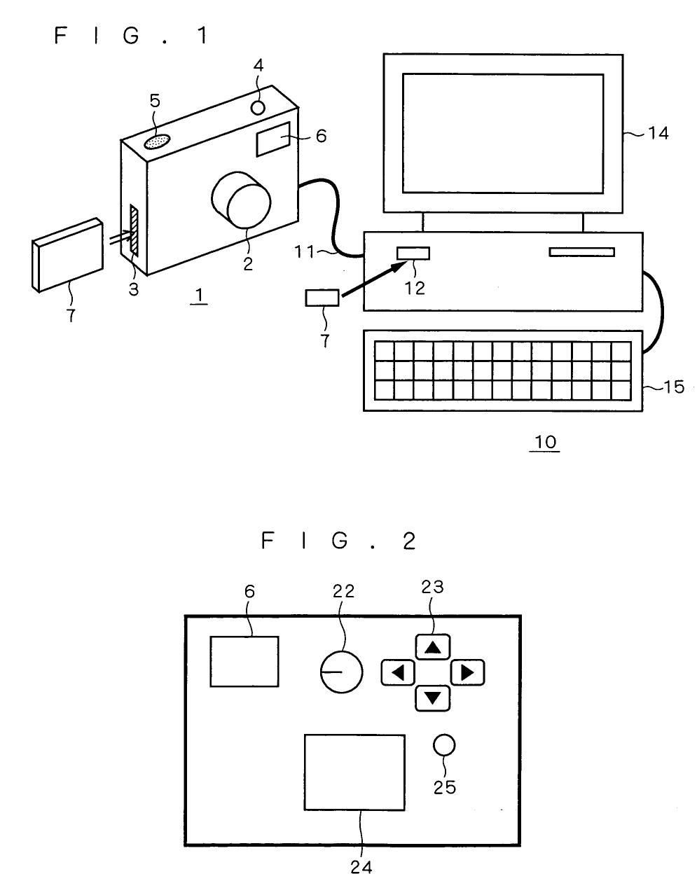

FIG. 1 shows a configuration of an image processing system according to a first preferred embodiment of the present invention. As shown in FIG. 1, a digital camera 1 serving as an image capturing apparatus and a PC (personal computer) 10 serving as an electronic processing terminal are connected to each other with a cable 11 for making communications under USB or the like.

The digital camera 1 has a lens device 2 and a viewfinder 6 on its front face; a main switch 4 and a shutter-release button 5 on its top face; and a media insertion slot 3 removably accepting a media 7 serving as a memory (recording medium) including a memory card and the like, on its side face.

The PC 10 has a monitor 14 for displaying information in the form of an image to a user and a keyboard 15 for a user to input information. The PC 10 further has a media insertion slot 12 removably accepting the media 7 on the front face of its body.

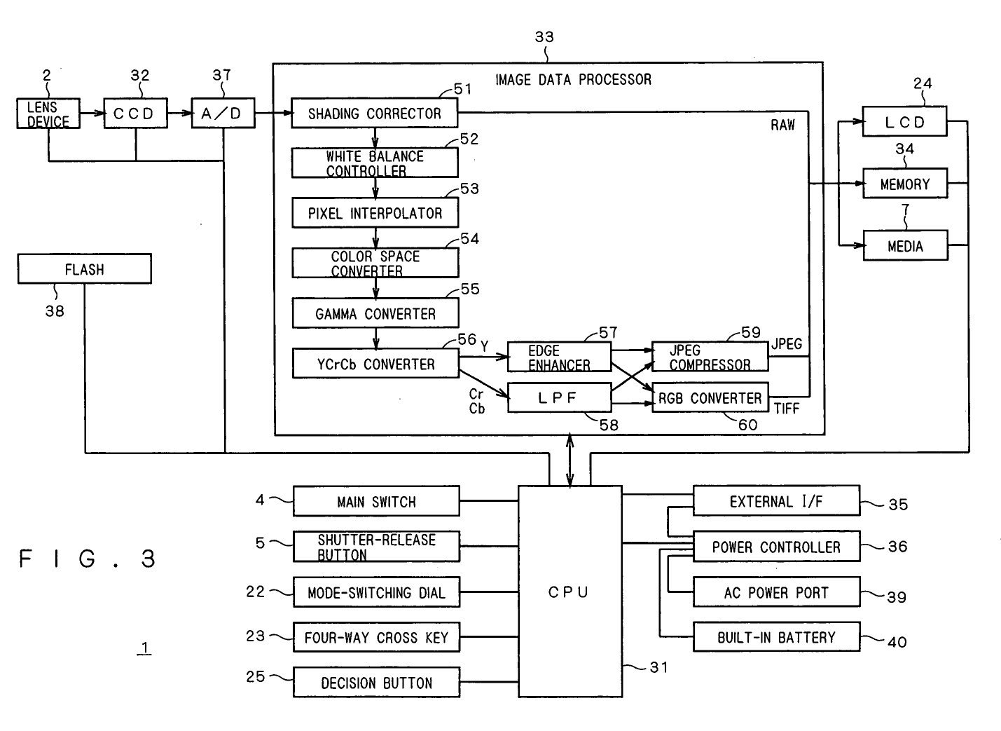

FIG. 2 is a rear view of the digital camera 1. As shown in FIG. 2, the digital camera 1 has on its rear face the viewfinder 6, a mode-switching dial 22, a four-way cross key 23, an LCD (liquid crystal monitor) 24 and a decision button 25.

The viewfinder 6 allows a user to view a subject therethrough. The mode-switching dial 22 is a dial for switching among modes such as a still image capturing mode for capturing a still image, a motion image capturing mode for capturing a motion image and a playback mode for playing back a captured image. The four-way cross key 23 is a key for selecting among various operations such as changing of zoom magnification. The LCD 24 is a screen for displaying image data. The decision button 25 is a button for deciding an operation.

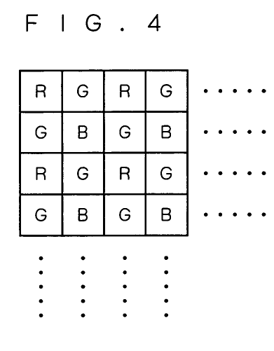

FIG. 3 is a detailed block diagram of the digital camera 1.

In FIG. 3, image data captured by a CCD 32 through the lens device 2 is converted into digital form in an AD converter 37, and then processed in an image data processor 33. The image data processed in the image data processor 33 is displayed on the LCD 24, stored in the media 7 or temporarily stored in a memory 34 serving as a built-in temporary memory.

The above-mentioned lens device 2, CCD 32, AD converter 37, image data processor 33, LCD 24, media 7 and memory 34 are controlled by a CPU 31. The image data processor 33 is capable of processing not only image data transmitted from the AD converter 37 but also image data stored in the media 7 or memory 34.

The CPU 31 controls the entire digital camera 1 including an external I/F (interface) 35 for transmitting image data or the like to/from the outside by communications under USB or the like via the cable 11, a power controller 36 for performing power control on the entire digital camera 1 and a flash 38 serving as a light emitter. The power controller 36 supplies power using any one of the external I/F 35, an AC power port 39 and a built-in battery 40.

Next, referring to FIG. 3, processing performed by the image data processor 33 in the case where image data is generated into a RAW file, a JPEG file or a TIFF file will be described.

The CCD 32 generates image data by image capturing through the lens device 2.

The generated image data is converted into digital form in the AD converter 37.

The image data having converted into digital form is subjected to compensation for insufficient illumination in an area corresponding to the periphery of the lens device 2 in a shading corrector 51.

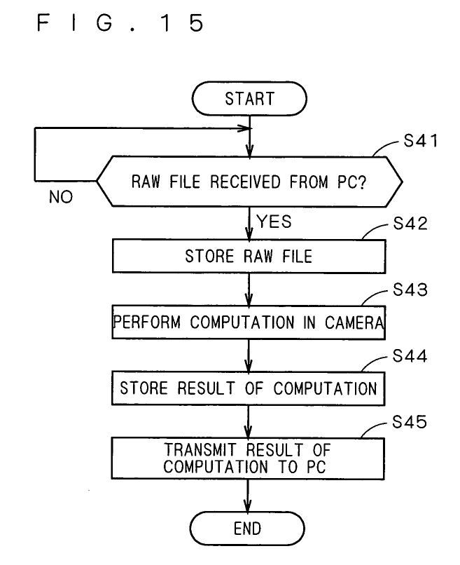

The image data having undergone compensation for insufficient illumination is generated directly into a RAW file in the RAW format. This RAW file contains image data of RAW format, tag information including image capturing information and the like and thumbnail image data, which will be described later referring to FIG. 14. In the JPEG or TIFF format, the image data is subjected to white balance control in a white balance controller 52 using predetermined gains corresponding to respective colors of R, G and B.

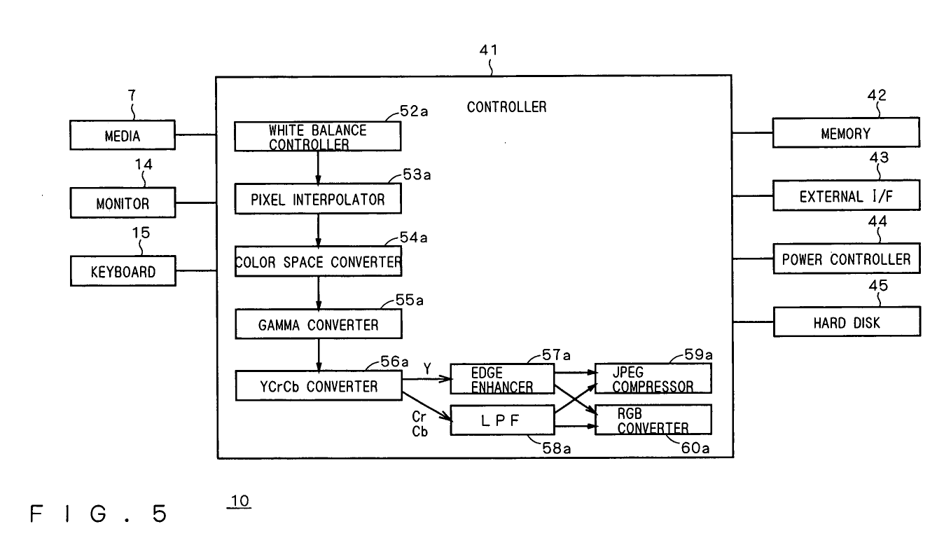

The image data having undergone white balance control is subjected to pixel interpolation in a pixel interpolator 53. Specifically, as shown in FIG. 4, such interpolation is necessary in the case where the CCD 32 is of 1 CCD type in which one pixel corresponds to only one color.

The image data having undergone pixel interpolation is subjected to color space conversion in a color space converter 54 as necessary into an sRGB color space, for example.

The image data having undergone color space conversion is subjected to gamma value correction in a gamma corrector 55.

The image data having undergone gamma correction is converted from RGB form into YcrCb form in a YCrCb converter 56. Accordingly, a luminance signal Y (luminance image data) and color difference signals (color difference image data) Cr, Cb are generated.

The generated luminance image data is subjected to sharpness adjustment in an edge enhancer 57. The generated color difference image data is subjected to smoothing in an LPF part 58.

In the JPEG format, the luminance image data having undergone sharpness adjustment and color difference image data having undergone smoothing are subjected to JPEG compression in a JPEG compressor 59. In the TIFF format, the luminance image data having undergone sharpness adjustment and color difference image data having undergone smoothing are converted into RGB form in an RGB converter 60.

The image data having undergone JPEG compression or image data having converted into RGB form is generated into a JPEG file or TIFF file, each containing tag information and thumbnail image data, and is stored in the media 7.

FIG. 5 is a detailed block diagram of the PC 10.

In FIG. 5, a controller 41 controls the entire PC 10 including a memory 42 serving as a built-in temporary memory, an external I/F 43 for transmitting image data or the like to/from the outside by communications under USB or the like through the cable 11, a power controller 44 for performing power control on the entire PC 10 and a hard disk 45 for storage.

The controller 41 includes a white balance controller 52a, a pixel interpolator 53a, a color space converter 54a, a gamma corrector 55a, a YCrCb converter 56a, an edge enhancer 57a, an LPF part 58a, a JPEG compressor 59a and an RGB converter 60a.

These processing parts of the controller 41 have similar functions as those having similar names provided in the image data processor 33 shown in FIG. 3. However, the controller 41 processes image data by software using a general-purpose functional processor, whereas the image data processor 33, including an ASIC having a specific processor specifically designed to a certain image processing function and the like, processes image data by hardware. Therefore, in image data processing, the processing speed of the image data processor 33 is higher than that of the controller 41. An image processing system according to the present invention focuses attention on this point, and is characterized in that, in image data processing in an image processing application for PC called a viewer, image data is transmitted from the PC 10 to the digital camera 1 and is processed in the image data processor 33.

Overall Operation

Hereinbelow, the overall operation of the image processing system shown in FIG. 1 will be discussed. In this image processing system, the PC 10 receives an image file generated in the digital camera 1 through the cable 11. Means of communication is not limited to the cable 11, but wireless LAN or the like may be employed. Alternatively, loading of the media 7 may be employed. In the following operation, the external I/F 43 of the PC 10 serves as an unprocessed data transmitter for transmitting image data or the like to be processed to the digital camera 1. The external I/F 35 of the digital camera 1 serves as a receiver for receiving image data or the like transmitted from the PC 10 as well as a processed data transmitter for transmitting processed image data having undergone processing to the PC 10. The image data processor 33 of the digital camera 1 serves as a processor specifically designed to an image processing function. The controller 41 of the PC 10 serves as an instruction part for giving an instruction to process image data.

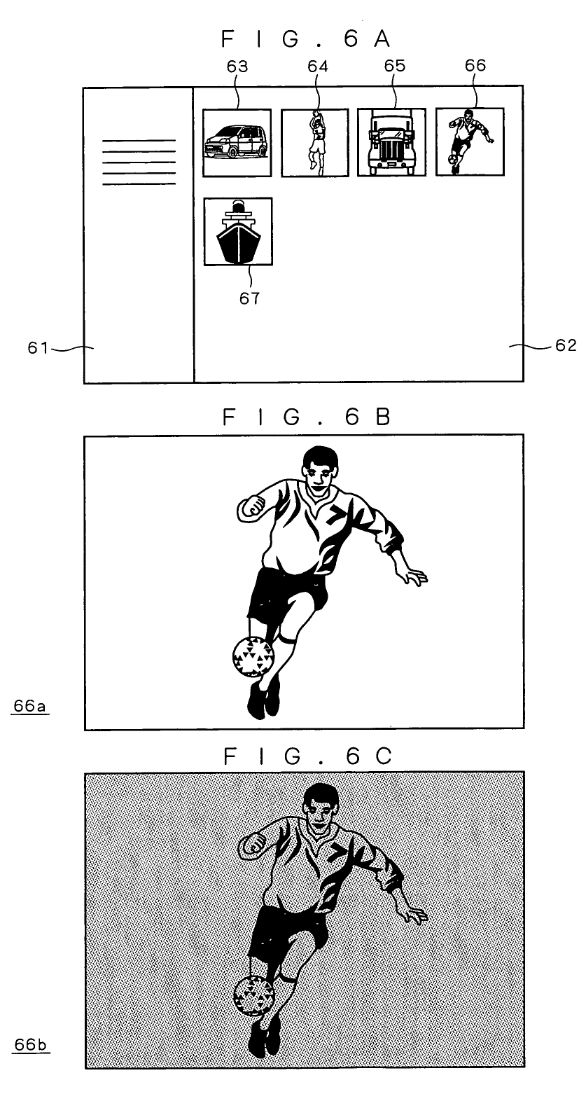

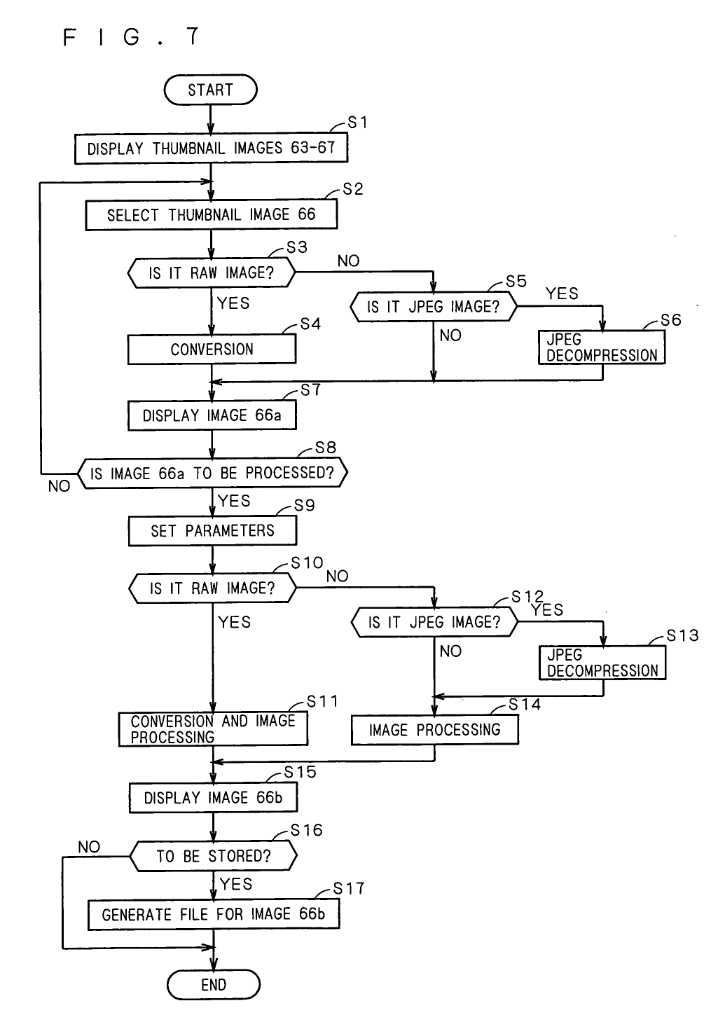

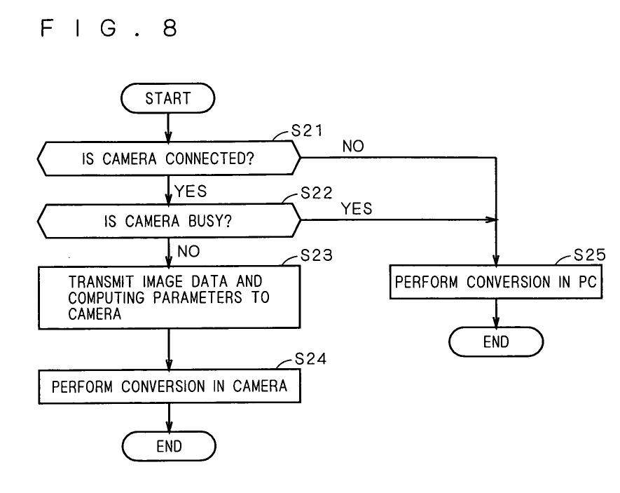

First, referring to FIGS. 6A to 6C, a basic operation of the image processing system will be discussed.

As shown in FIG. 6A, when a user starts up a viewer on the PC 10, the name of image data and a thumbnail image in which image data is compressed are displayed on the monitor 14. More specifically, a folder tree including the names of a plurality of pieces of image data are displayed in a folder tree display area 61, and a plurality of thumbnail images 63 to 67 of respective image files are displayed in a thumbnail display area 62.

Next, as shown in FIG. 6B, when the user selects the thumbnail image 66 among the thumbnail images 63 to 67 by operating the keyboard 15 or the like, an image 66a corresponding to the thumbnail image 66 is displayed all over the monitor 14.

Next, the user sets desired computing parameters for processing the image 66a by operating the keyboard 15 or the like. As such computing parameters, a gain in white balance control, a gamma value in gamma correction, the degree of edge enhancement, the range of smoothing and a weighting coefficient in LPF and the like can be set.

Next, as shown in FIG. 6C, the PC 10 displays an image 66b generated by processing the image 66a based on the computing parameters as set, on the monitor 14. Accordingly, the user can select and process any image based on desired computing parameters. FIG. 6C shows a case in which gamma correction has been conducted to reduce the luminance as a whole.

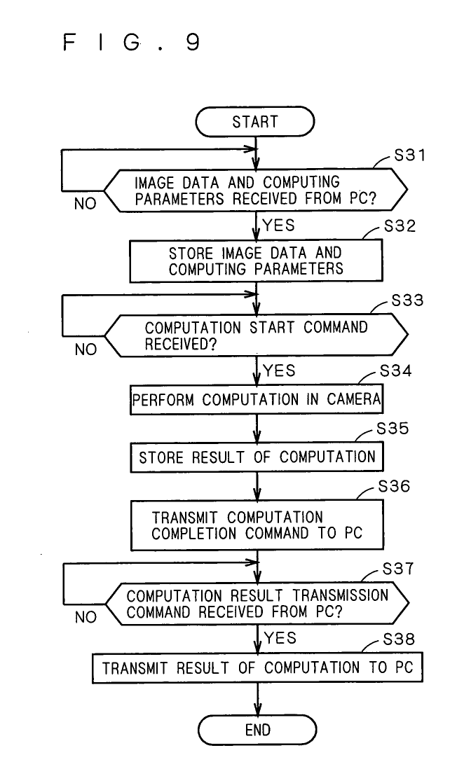

Next, the operation of the image processing system will be discussed in detail referring to a flow chart shown in FIG. 7.

First, in step S1, the thumbnail images 63 to 67 (and the folder tree) are displayed on the monitor 14.

Next, the process proceeds into step S2, in which the user selects the thumbnail image 66.

Then, the process proceeds into step S3, in which the PC 10 judges whether the image 66a corresponding to the image 66 is in the RAW format (RAW image). When the image 66a is a RAW image, the process proceeds into step S4. When the image 66a is not a RAW image, the process proceeds into step S5.

In step S4, the image 66a which is a RAW image is subjected to conversion processing (here, conversion into a displayable image representing format). At this time, image data of the image 66a and computing parameters are transmitted from the PC 10 to the digital camera 1 through the cable 11. As computing parameters, default settings of the PC 10 may be used. Since the image 66a only needs to be displayable at this stage on the precondition that image processing is performed in a later step, computing parameters for conversion may be provided in the digital camera 1.

The image data received by the digital camera 1 is sequentially subjected to processing based on computing parameters in the white balance controller 52, pixel interpolator 53, color space converter 54, gamma converter 55, YCrCb converter 56, edge enhancer 57, LPF part 58 and RGB converter 60. The image data having undergone the above processing is transmitted from the digital camera 1 to the PC 10 through the cable 11. Then, the process proceeds into step S7.

In step S5, the PC 10 judges whether the image 66a is in the JPEG format (JPEG image). When the image 66a is a JPEG image, the process proceeds into step S6, in which JPEG decompression is performed, and the process proceeds into step S7. When the image 66a is not a JPEG image, it is in the TIFF format (TIFF image), which does not require either conversion or JPEG decompression, and the process proceeds directly into step S7.

In step S7, the image 66a is displayed on the monitor 14. More specifically, in the case of displaying the image 66a from an image file generated in the digital camera 1, conversion processing including white balance control and subsequent steps is not necessary for a JPEG or TIFF image, but is necessary for a RAW image. Therefore, conversion processing is performed in the image data processor 33 having a higher processing speed, not in the controller 41. This allows processing time for a RAW image to be shortened.

Next, the process proceeds into step S8, in which the PC 10 asks the user whether to perform predetermined image processing on the image 66a through the monitor 14. The user replies whether to perform processing on the image 66a by operating the keyboard 15 or the like. In the case where processing is to be performed, the process proceeds into step S9. In the case where processing is not to be performed, the process returns to step S2, in which another desired thumbnail image is selected among the thumbnail images 63 to 67.

In step S9, the user sets desired computing parameters for processing the image 66a by operating the keyboard 15 or the like.

Next, the process proceeds into step S10, in which the PC 10 judges whether the image 66a is a RAW image. When the image 66a is a RAW image, the process proceeds into step S11. When the image 66a is not a RAW image, the process proceeds into step S12.

In step S11, the image 66a which is a RAW image is processed. In this case, image processing is performed on RAW image data yet to undergo conversion processing in step S4. The RAW image data corresponding to the image 66a and the computing parameters as set in step S9 are transmitted from the PC 10 to the digital camera 1 through the cable 11.

The RAW image received by the digital camera 1 is sequentially subjected to processing based on the computing parameters in the white balance controller 52, pixel interpolator 53, color space converter 54, gamma converter 55, YCrCb converter 56, edge enhancer 57, LPF part 58 and RGB converter 60. This means conversion and image processing are performed. The image data having undergone the above processing is transmitted from the digital camera 1 to the PC 10 through the cable 11. The process proceeds into step S15.

In step S12, the PC 10 judges whether the image 66a is a JPEG image. When the image 66a is a JPEG image, the process proceeds into step S13, in which JPEG decompression is performed, and then the process proceeds into step S14. When the image 66a is not a JPEG image, it is a TIFF image, which does not require JPEG decompression, and the process proceeds directly into step S14.

In step S14, the PC 10 performs image processing on image data corresponding to the image 66a which is a JPEG or TIFF image.

Since a JPEG or TIFF image does not require either white balance control or pixel interpolation and only those among subsequent steps for which parameters are determined need to be performed, processing is performed in the PC 10. More specifically, steps for which parameters are determined among steps performed in the color space converter 54, gamma converter 55, YCrCb converter 56, edge enhancer 57, LPF part 58 are performed sequentially. Then, the process proceeds into step S15.

In step S15, the result of image processing is displayed. The user can thereby check whether or not a desired result has been achieved. Then, the process proceeds into step S16.

In step S16, the PC 10 asks the user whether to store the image. When the image is to be stored, the process proceeds into step S17. When the image is not to be stored, the process is finished.

In step S17, a file is generated in a format corresponding to the RAW image processed in step S11 or the JPEG or TIFF image processed in step S14, and the PC 10 stores the file in the memory 42 or media 7. Through the above steps S1 to S17, a series of processes by the viewer is completed.

Conversion Processing

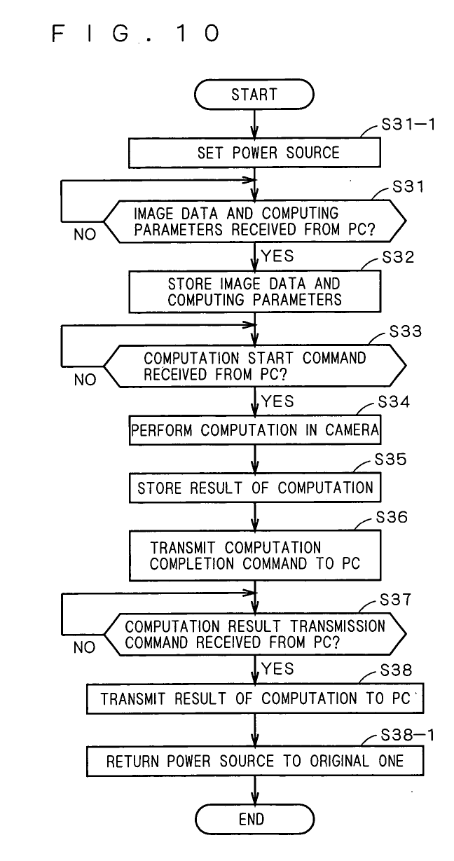

As described, in the image processing system according to the present embodiment, the digital camera 1, not the PC 10, performs conversion processing on a RAW image. Hereinbelow, steps for the conversion processing will be discussed referring to FIGS. 8 and 9.

First, the operation of the PC 10 will be discussed referring to the flow chart shown in FIG. 8.

First, in step S21, the PC 10 judges whether the digital camera 1 is connected thereto. When the digital camera 1 is connected, the process proceeds into step S22. When the digital camera 1 is not connected, the process proceeds into step S25.

Next, in step S22, the PC 10 judges whether the digital camera 1 is busy (executing another process). When it is busy, the process proceeds into step S25. When it is not busy, image processing is executable in the digital camera 1, and thus, the process proceeds into step S23.

In step S23, the PC 10 transmits image data and computing parameters to the digital camera 1, and the process proceeds into step S24. More specifically, in steps S21 to S23, the PC 10 judges whether image processing is executable in the digital camera 1 referring to information about the digital camera 1, to thereby perform transmission control.

In step S24, the PC 10 gives an instruction to cause the digital camera 1 to perform image processing, and then, receives image data having been processed from the digital camera 1.

In step S25, the PC 10 itself performs image processing using the controller 41 without transmitting image data to the digital camera 1. In this case, image processing is performed by software in the PC 10 although it takes longer time than in the digital camera 1. Through the above steps S21 to S25, the operation of the PC 10 is completed.

Next, the operation of the digital camera 1 will be discussed referring to the flow chart shown in FIG. 9.

First, in step S31, the digital camera 1 judges whether image data and computing parameters have been received from the PC 10. Only when they have been received, the process proceeds into step S32.

In step S32, the digital camera 1 stores the received image data and computing parameters in the memory 34 or media 7. The volume of data increases by processing image data. In the case where either of the memories lacks enough free space for storing processed image data, the digital camera 1 informs the PC 10 that the processed image data cannot be stored due to the lack of enough space. The judgment as to whether or not storage is possible may be made by the PC 10, not by the digital camera 1. More specifically, in the flow chart shown in FIG. 8, subsequently to step S22, the PC 10 judges through the cable 11 whether the memory of the digital camera 1 has enough free space for storing processed image data. When there is enough free space, the process proceeds into step S23, and when there is not enough free space, the process proceeds into step S25.

Next, the process proceeds into step S33, the digital camera 1 judges whether a computation start command (processing start signal) has been received from the PC 10. Only when the command has been received, the process proceeds into step S34.

In step S34, the digital camera 1 processes the received image data based on the received computing parameters.

Next, the process proceeds into step S35, in which the digital camera 1 stores the result of computation (processed image data) in the memory 34 or media 7.

Next, the process proceeds into step S36, in which the digital camera 1 transmits a computation completion command to the PC 10.

Next, the process proceeds into step S37, in which the digital camera 1 judges whether a computation result transmission command (transmission request signal) has been received from the PC 10. Only when the command has been received, the process proceeds into step S38.

In step S38, the digital camera 1 transmits the result of computation (processed image data) to the PC 10.

Through the above steps S31 to S38, the operation of the digital camera 1 is completed. The above description is directed to the case of processing one image (66a), however, in the case of processing a plurality of images, steps S31 to S38 may be repeated by the number of cycles equal to that of images. Alternatively, a plurality of pieces of image data in a batch may be transmitted to the digital camera 1, subjected to a computation and transmitted back to the PC 10, which means steps S31 to S38 are performed only by one cycle.

As described, the image processing system according to the present embodiment performs conversion processing in the specific processor (image data processor 33) in the digital camera 1, not in the general-purpose functional processor (controller 41) in the PC 10. This can achieve the effect of shortening processing time.

### Second Preferred Embodiment

In the first preferred embodiment, only sections of the digital camera 1 related to computing and communications (transmission of image data) are used in the operation shown in the flow chart of FIG. 9. Therefore, in the operation, power supply to sections of the digital camera 1 not related to computing and communications may be stopped.

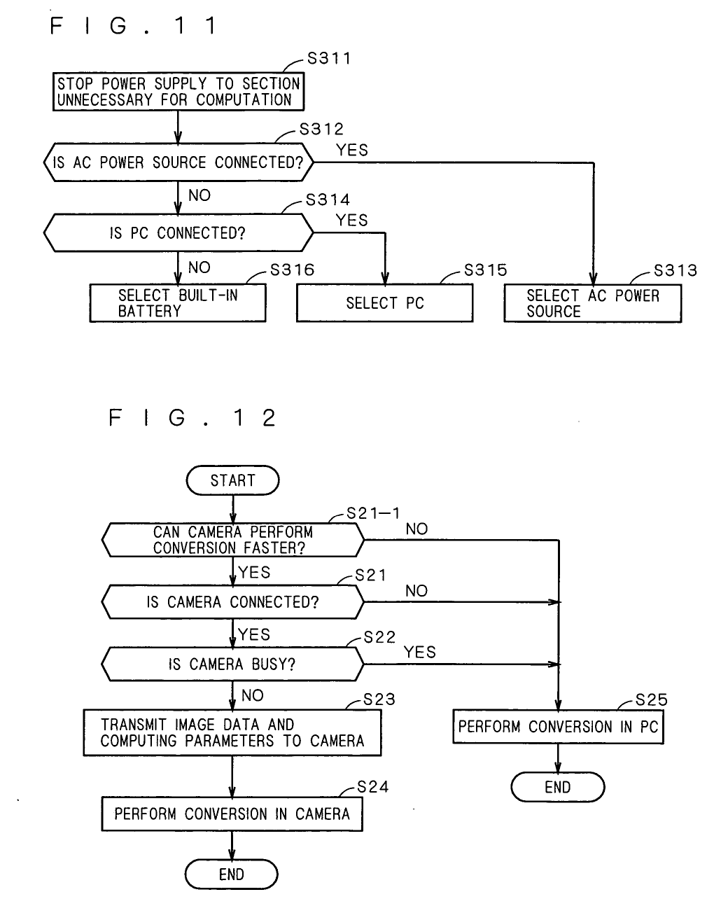

FIG. 10 is a flow chart of an operation of the digital camera 1 according to a second preferred embodiment of the present invention. The flow chart shown in FIG. 10 differs from that of FIG. 9 in that step S31-1 prior to step S31 and step S38-1 subsequent to step 38 are added.

In step S31-1, the digital camera 1 uses the power controller 36 to stop power supply to the sections not related to computing and communications as well as to switch the power source to an optimum one. In step S38-1, the digital camera 1 uses the power controller 36 to restart power supply to the sections to which power supply has been stopped as well as to switch the power source to the original one.

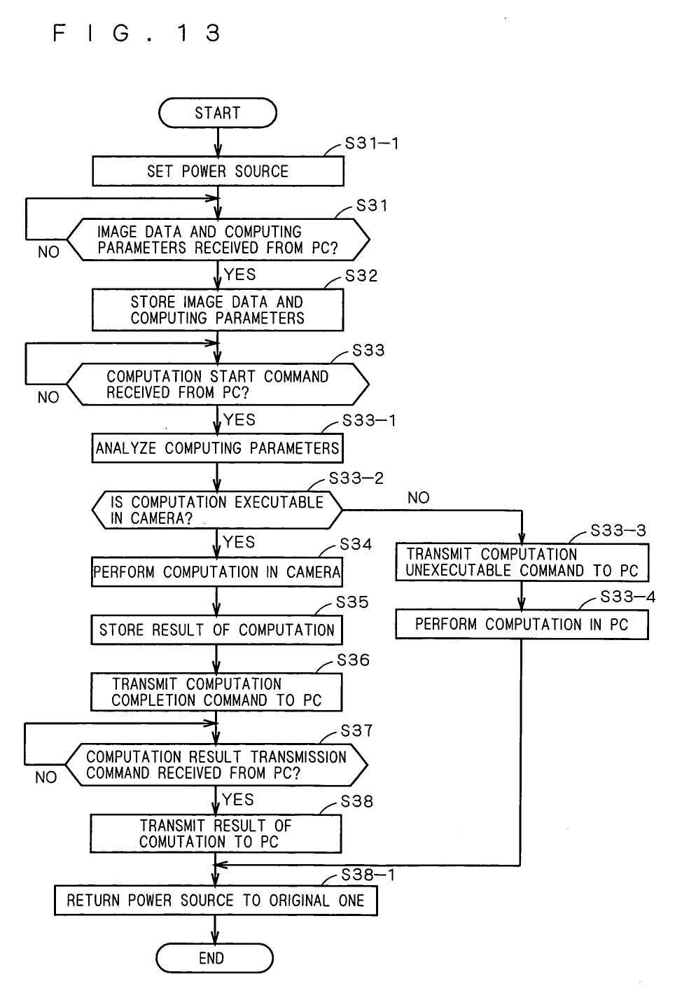

FIG. 11 is a flow chart of a detailed procedure of step S31-1.

First, in step S311, the power controller 36 stops power supply to the CCD 32, flash 38 and the like not required for computing and communications. In other words, the power controller 36 serving as a power supply controller according to the present invention selectively supplies power to the receiver, processor and processed data transmitter.

Next, in step S312, the power controller 36 judges whether an AC power is connected to the AC power port 39. When the AC power is connected, the process proceeds into step S313, in which the AC power is selected as a power source. When the AC power is not connected, the process proceeds into step S314.

Next, in step S314, the power controller 36 judges whether the PC 10 is connected to the external I/F 35 of the digital camera 1 with the cable 11. When the PC 10 is connected, the process proceeds into step S315, in which the PC 10 is selected as a power source. In this case, power is supplied from the PC 10 through the external I/F 35. When the PC 10 is not connected, the process proceeds into step S316, in which the built-in battery 40 (electricity storage unit) is selected as a power source.

As described, in the image processing system according to the present embodiment, the digital camera 1 stops power supply to the sections not related to computation and communications during a computation to thereby reduce power consumption, and selects a power source from the AC power, PC 10 and built-in battery 40 giving priority in this order. Therefore, supplying power from outside the digital camera 1 to the extent possible can achieve the effect of stabilizing operation as compared to the case of using the built-in battery 40 only.

In the case where abnormality occurs in a power source during a computation, the power controller 36 may exercise control such that a defective power source is switched to another one having no defect through the procedure shown in steps S312 to 316 in FIG. 11. This can achieve the effect of stabilizing operation more.

### Third Preferred Embodiment

In the operation shown in the flow chart of FIG. 8 according to the first preferred embodiment, when it is judged in step S21 that the digital camera 1 is connected, and it is judged in step S22 that the digital camera 1 is not busy, then, the digital camera 1 performs conversion processing in step S24 after the PC 10 transmits image data and computing parameters to the digital camera 1 in step S23. In some cases, however, the PC 10 may perform conversion processing faster than the digital camera 1 depending on details of the conversion processing.

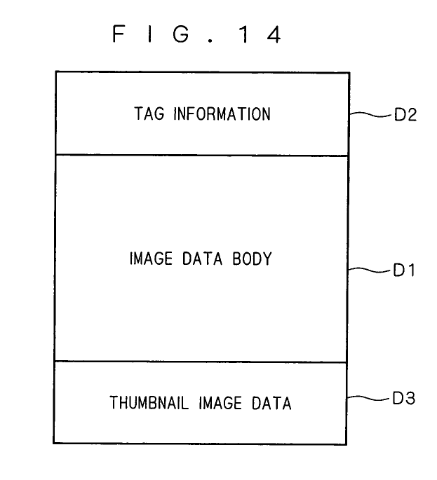

FIG. 12 is a flow chart of the operation of the digital camera 1 according to a third preferred embodiment. The flow chart of FIG. 12 differs from that of FIG. 8 in that step S21-1 prior to step S21 is added.

In step S21-1, the PC 10 judges which of the digital camera 1 and PC 10 performs conversion processing faster. This judgment is made based on the computing power of the digital camera 1, the computing power of the PC 10, communications time required for data transmission between the digital camera 1 and PC 10 and the volume of computation. More specifically, computing time predicted by the following equations (1) and (2), that is, first predicted time T1 and second predicted time T2 are calculated and compared.
First predicted time T1=volume of computation/computing power of digital camera 1+communications time (1)
Second predicted time T2=volume of computation/computing power of PC 10 (2)

In the equations (1) and (2), the computing power of each of the digital camera 1 and PC 10 is obtained based on the number of clock cycles and storage space of a processor of each of the digital camera 1 and PC 10, and the like. The volume of computation is determined based on the volume of data and details of computation, and the volume of data is obtained from the number of pixels of an image. The communications time is obtained by dividing the volume of data by the transmission speed of the communications line (cable 11) between the digital camera 1 and PC 10.

When T1<T2 holds, the PC 10 judges that the digital camera 1 can perform conversion processing faster, and the process proceeds into step S21. When T1>T2 holds, the PC 10 judges itself as being able to perform conversion processing faster, and the process proceeds into step S25, in which conversion processing is performed by the PC 10.

As described, in the image processing system according to the present embodiment, the PC 10 itself performs conversion processing without transmitting image data to the digital camera 1 in the case where the PC 10 judges itself as being able to perform conversion processing faster. This can achieve the effect of shortening processing time in addition to the effect achieved by the first preferred embodiment.

### Fourth Preferred Embodiment

In the operation shown in the flow chart of FIG. 9 according to the first preferred embodiment, the digital camera 1, upon receipt of the computation start command from the PC 10 in step S33, brings the process to proceed into step S33 to execute a computation. As described, however, the image data processor 33 is specifically designed to the image processing function, and therefore, has a higher processing speed but lower computing flexibility than the CPU 31. This means some computations depending on their details may be executable in the controller 41 but may be unexecutable in the image data processor 33, thus resulting in an error.

FIG. 13 is a flow chart of an operation of the PC 10 according to a fourth preferred embodiment of the present invention. The flow chart of FIG. 13 differs from that of FIG. 10 in that steps S33-1 to S33-2 are added between steps S33 and S34 and steps S33-3 to S33-4 branching off from step S33-2 are added.

In step S33-1, the digital camera 1 analyzes whether the computing parameters stored in step S32 fall within a range that can be processed by the image data processor 33. Such range is determined based on the configuration of the image data processor 33 such that, for instance, a gain of white balance control ranges from 0.5 to 2.0, a gamma value from 1.0 to 2.0, a gain of edge enhancement from 1.0 to 2.0 and smoothing size of LPF is ±3.

Next, the process proceeds into step S33-2, in which, when these computing parameters fall within the above ranges, it is judged that computing is executable, and the process proceeds into step S34, in which a computation is performed in the digital camera 1. When these computing parameters do not fall within the above ranges, it is judged that computing is unexecutable, and the process proceeds into step S33-3, in which the digital camera 1 transmits a computation unexecutable command to the PC 10. Then, the process proceeds into step S33-4, in which the PC 10 performs a computation.

As described, in the image processing system according to the present embodiment, the PC 10 performs a computation when it is judged that the digital camera 1 cannot perform a computation. This can achieve the effect of reducing errors associated with computations.

Although it is described above that the PC 10 performs a computation when the computing parameters do not fall within the executable ranges in step S33-2, an approximate computation may be performed in the digital camera 1 using optimum parameters within executable ranges. For instance, when a gamma value is 2.5 which exceeds the upper limit, the digital camera 1 performs processing using a gamma value of 2.0 which is the upper limit. Therefore, it is possible to shorten processing time while reducing errors associated with computations.

Further, it is described above that the analysis and judgment in steps S33-1 and S33-2 are performed by the digital camera 1, however, this judgment may be performed by the PC 10 before transmitting image data and computing parameters to the digital camera 1. In the case where the digital camera 1 cannot perform a computation, it is possible to cause the PC 10 not to transmit image data and computing parameters to the digital camera 1 because the PC 10 makes the judgment. This can achieve improved processing efficiency of the image processing system.

### Fifth Preferred Embodiment

In the conversion processing shown in the flow chart of FIG. 9 according to the first preferred embodiment, the digital camera 1 receives image data and computing parameters from the PC 10 in step S32. The image data and computing parameters may be generated into different files, or may be combined together into one piece of data in the RAW format.

FIG. 14 is a schematic view of the structure of a RAW file according to a fifth preferred embodiment of the present invention. The RAW file contains an image data body D1 together with tag information D2 (header portion) and thumbnail information D3. The tag information D2 contains computing parameters in addition to management information such as the date of capture and size of the image data body D1. The thumbnail information D3 is data having a relatively small number of pixels for displaying the thumbnail image 66 in FIG. 6A.

As described, in the image processing system according to the present embodiment, since computing parameters are described in the tag information D2, a RAW image data and computing parameters can be handled as one piece of data. Therefore, it is possible to handle the RAW image data and computing parameters easily.

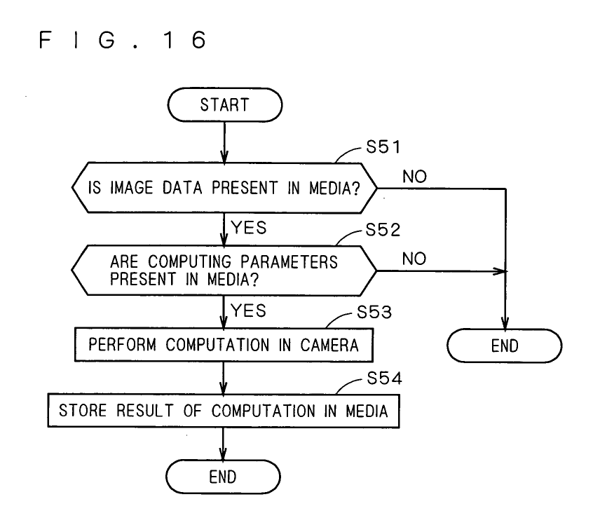

In the flow chart shown in FIG. 9, the digital camera 1 waits for the computation start command in step S33 and the computation result transmission command in step S37 before proceeding into the subsequent steps, respectively. For instance, however, as shown in steps S41 to S45 in the flow chart of FIG. 15, the digital camera 1 may cause the process to proceed into the subsequent steps without waiting for these commands. In FIG. 15, the digital camera 1, upon confirmation of receipt of a RAW file in step S41, automatically performs a computation and transmits the result of computation (image data having been processed) to the PC 10. This can simplify the operation and shorten processing time.

### Sixth Preferred Embodiment

In the operation shown in the flow chart of FIG. 9 according to the first preferred embodiment, the digital camera 1 transmits/receives data to/from the PC 10 through the cable 11. However, the data transmission may be performed using the media 7 instead of the cable 11. More specifically, data may be transferred from the PC 10 to the digital camera 1 by pulling out the media 7 with image data and computing parameters recorded thereon in the PC 10 from the media insertion slot 12 and inserting the media 7 into the media insertion slot 3 of the digital camera 1.

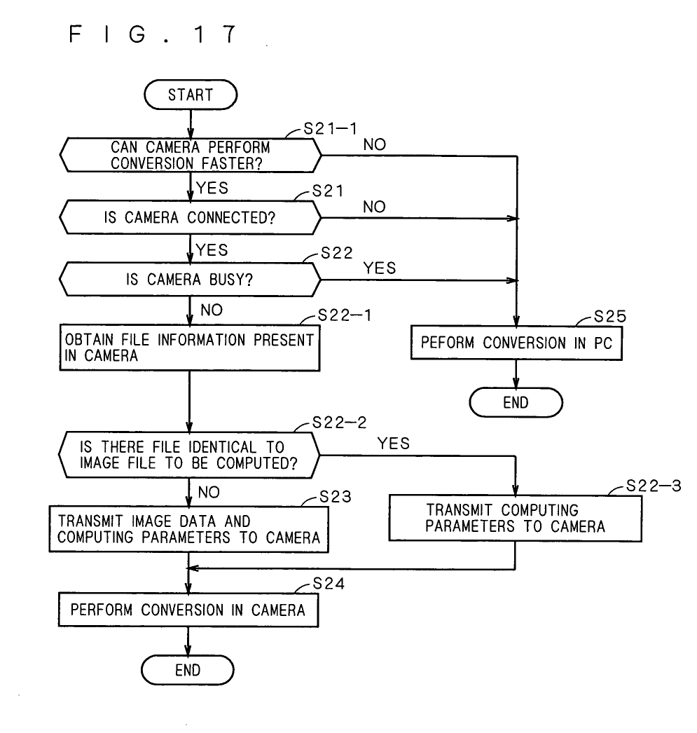

FIG. 16 is a flow chart of an operation of the digital camera 1 according to a sixth preferred embodiment of the present invention.

First, in step S51, the digital camera 1 judges whether image data is present in the media 7. When image data is present, the process proceeds into step S52, and when no image data is present, the process is finished.

In step S52, the digital camera 1 judges whether computing parameters are present in the media 7. When computing parameters are present, the process proceeds into step S53, and when no computing parameters are present, the process is finished.

In step S53, the digital camera 1 performs a computation based on detected image data and computing parameters.

Next, the process proceeds into step S54, in which the digital camera 1 records the result of computation (image data having been processed) on the media 7. Through the above steps S51 to S54, the operation of the digital camera 1 is completed.

As described, in the image processing system according to the present embodiment, the digital camera 1 receives data employing the media 7 instead of the cable 11 used in the first preferred embodiment. Therefore, the PC 10 can execute another job without the need to carry out communications with the digital camera 1 while the digital camera 1 is performing a computation. This can achieve more improved processing efficiency.

### Seventh Preferred Embodiment

In the operation shown in the flow chart of FIG. 12 according to the third preferred embodiment, when it is judged in step S21-1 that the digital camera 1 can perform a computation faster than the PC 10, it is judged in step S21 that the digital camera 1 is connected, and it is judged in step S22 that the digital camera 1 is not busy, then, the digital camera 1 performs conversion processing in step S24 after the PC 10 transmits image data and computing parameters to the digital camera 1 in step S23. However, when image data to be computed is already present in the digital camera 1, only computing parameters need to be transmitted omitting transmission of image data.

FIG. 17 is a flow chart of an operation of the PC 10 according to a seventh preferred embodiment of the present invention. The flow chart of FIG. 17 differs from that of FIG. 12 in that steps S22-1 and S22-2 are added between steps S22 and S23, and step S22-3 branching off from step S22-2 is added.

In step S22-1, the PC 10 searches for image data to be computed in the digital camera 1. This search is made based on attribute information such as the name of a data file, the date of file generation, capacity and the like. More specifically, the PC 10 makes a request of the digital camera 1 to provide file attribute information. The digital camera 1 searches the contents of the media 7 inserted into the media insertion slot 12 to obtain file attribute information and provide it for the PC 10. The PC 10 checks whether a file identical to image data to be computed is stored in the digital camera 1. When a file identical to image data is stored, the process proceeds into step S22-3, and when a file identical to image data is not stored, the process proceeds into step S23. In step S22-3, the PC 10 transmits only computing parameters (and computation start command) omitting transmission of image data to the digital camera 1.

Generally, in image capturing in the digital camera 1 and image processing (conversion by the viewer) in the PC 10, a user follows a procedure for capturing an image by the digital camera 1, then connecting the digital camera 1 and PC 10, and capturing image data in the digital camera 1 into the PC 10. Therefore, image data to be computed may already be present in the digital camera 1 in the case where the digital camera 1 having captured an image is connected to the PC 10 for image processing Just after image capturing.

As described, in the image processing system according to the present embodiment, transmission of image data from the PC 10 is omitted in the case where image data to be computed is already present in the digital camera 1. This can achieve more improved processing efficiency.

While the invention has been shown and described in detail, the foregoing description is in all aspects illustrative and not restrictive. It is therefore understood that numerous modifications and variations can be devised without departing from the scope of the invention.

What is claimed is:

1. An image processing system comprising an image capturing apparatus and an electronic processing terminal connectable to said image capturing apparatus, wherein
said electronic processing terminal includes:
an instruction part for giving an instruction to perform predetermined processing on image data; and
an unprocessed data transmitter for transmitting said image data to be subjected to said predetermined processing to said image capturing apparatus, and
said image capturing apparatus includes:
a receiver for receiving said image data transmitted from said electronic processing terminal;
a processor for performing said predetermined processing on said image data as received to obtain processed image data, said processor having a specific processor specifically designed to a certain image processing function including said predetermined processing; and
a processed data transmitter for transmitting said processed image data to said electronic processing terminal.

2. The image processing system according to claim 1, wherein
said image data is in RAW format, and
said predetermined processing is conversion into a displayable image representing format.

3. The image processing system according to claim 1, wherein
said electronic processing terminal further includes:
a judging part for judging whether to transmit said image data to said image capturing apparatus by comparing first predicted time required in the case where said image data is subjected to said predetermined processing in said electronic processing terminal and second predicted time required in the case where said image data is transmitted to said image capturing apparatus to be subjected to said predetermined processing in said image capturing apparatus and transmitted to said electronic processing terminal; and
a transmitter for transmitting said image data to said image capturing apparatus using said unprocessed data transmitter when said second predicted time is shorter than said first predicted time.

4. The image processing system according to claim 1, wherein
said processed data transmitter transmits said processed image data to said electronic processing terminal in response to the completion of said predetermined processing on said image data.

5. The image processing system according to claim 1, wherein
said image capturing apparatus further includes:
a memory for storing said processed image data; and
a part for causing said memory to store said processed image data as well as informing said electronic processing terminal of the completion of said predetermined processing.

6. The image processing system according to claim 5, wherein
said processed data transmitter transmits said processed image data to said electronic processing terminal in response to a transmission request signal from said electronic processing terminal.

7. The image processing system according to claim 1, wherein
said electronic processing terminal transmits a batch of a plurality of pieces of image data to be subjected to said predetermined processing to said image capturing apparatus.

8. The image processing system according to claim 1, wherein
said image capturing apparatus further includes:
a memory for storing said processed image data; and
a part for judging whether it is possible to store said processed image data in said memory, and when it is impossible to store said processed image data, informing said electronic processing terminal of the impossibility.

9. The image processing system according to claim 5, wherein
said memory is a removable recording medium.

10. The image processing system according to claim 1, wherein
said electronic processing terminal further includes a transmission controller for judging whether said predetermined processing is executable on said image data in said image capturing apparatus referring to information about said image capturing apparatus, and when it is judged that said predetermined processing is executable, transmitting said image data to said image capturing apparatus using said unprocessed data transmitter.

11. The image processing system according to claim 10, wherein
said transmission controller judges whether said predetermined processing is executable on said image data in said image capturing apparatus depending on whether said image capturing apparatus is executing another process.

12. An image capturing apparatus connectable to an electronic processing terminal having an instruction part for giving an instruction to perform predetermined processing on image data and an unprocessed data transmitter for transmitting said image data to be subjected to said predetermined processing, said image capturing apparatus comprising:
a receiver for receiving said image data transmitted from said electronic processing terminal;
a processor for performing said predetermined processing on said image data as received to obtain processed image data, said processor having a specific processor specifically designed to a certain image processing function including said predetermined processing; and
a processed data transmitter for transmitting said processed image data to said electronic processing terminal.

13. An electronic processing terminal connectable to an image capturing apparatus having a receiver for receiving image data to be subjected to predetermined processing, a processor for performing said predetermined processing on said image data as received to obtain processed image data, said processor having a specific processor specifically designed to a certain image processing function including said predetermined processing and a processed data transmitter for transmitting said processed image data, said electronic processing terminal comprising:
an instruction part for giving an instruction to perform said predetermined processing on said image data; and
an unprocessed data transmitter for transmitting said image data to be subjected to said predetermined processing to said image capturing apparatus.

14. The image processing system according to claim 1, wherein
said unprocessed data transmitter transmits a parameter indicating details of said predetermined processing as well as said image data, to said receiver.

15. The image capturing apparatus according to claim 12, wherein
said unprocessed data transmitter transmits a parameter indicating details of said predetermined processing as well as said image data, to said receiver.

16. The electronic processing terminal according to claim 13, wherein
said unprocessed data transmitter transmits a parameter indicating details of said predetermined processing as well as said image data, to said receiver.

17. The image capturing apparatus according to claim 12, wherein
said image data is in RAW format, and
said predetermined processing is conversion into a displayable image representing format.

18. The electronic processing terminal according to claim 13, wherein
said image data is in RAW format, and
said predetermined processing is conversion into a displayable image representing format.
